(19) United States
(12) Patent Application Publication
(10) Pub. No.: US 2026/0156462 A1
(43) Pub. Date: Jun. 4, 2026

(54) COMMUNICATION METHOD AND DEVICE

(71) Applicant: GUANGDONG OPPO MOBILE TELECOMMUNICATIONS CORP., LTD., Dongguan (CN)

(72) Inventors: Lihui XIONG, Dongguan (CN); Lu GAN, Dongguan (CN); Xin YOU, Dongguan (CN); Xue LIN, Dongguan (CN)

(21) Appl. No.: 19/465,561

(22) Filed: Jan. 30, 2026

Related U.S. Application Data
(63) Continuation of application No. PCT/CN2023/133131, filed on Nov. 22, 2023.

(51) Int. Cl. H04W 12/041; H04W 12/0431; H04W 12/10; H04W 36/08

(52) U.S. Cl. CPC H04W 12/041; H04W 12/0431; H04W 12/10; H04W 36/08

(57) ABSTRACT

A terminal includes a processor and a memory communicating with the processor. The memory is configured to store instructions which, when executed by the processor, cause the terminal to perform: receiving first configuration information from a first access network device, wherein the first configuration information comprises first security parameter(s) corresponding to at least one candidate access network device, and the first security parameter(s) comprise at least one of: an indication of a key derivation manner, or a first next hop chaining counter (NCC).

### CROSS-REFERENCE TO RELATED APPLICATION

The present disclosure is a Continuation Application of PCT/CN2023/133131 filed Nov. 22, 2023, which is incorporated herein by reference in its entirety.

### TECHNICAL FIELD

The present application relates to the field of communication, and more particularly, to a communication method, a device, a non-transitory computer-readable storage medium, a computer program product, and a computer program.

### BACKGROUND

In the prior art, intra-centralized unit (CU) L1/L2-triggered mobility (LTM) mainly involves the L1/L2 signaling-triggered cell handover within the same base station, and does not involve inter-base station cell handover. Consequently, the related procedures for updating security parameters are not involved. However, introducing inter-CU LTM is discussed in relevant protocols, which may lead to scenarios where the current cell in which a terminal is located and a target cell to be handed over belong to different base stations. This necessitates consideration of how to address the issue of security parameter update caused by base station switch.

### SUMMARY

The embodiments of the present application provide a communication method, a device, a non-transitory computer-readable storage medium, a computer program product, and a computer program.

The embodiments of the present application provide a communication method performed by a terminal, which includes:
receiving first configuration information from a first access network device, where the first configuration information includes first security parameter(s) corresponding to at least one candidate access network device, and the first security parameter(s) include at least one of: an indication of a key derivation manner, or a first NCC.

The embodiments of the present application provide a communication method performed by a first access network device, which includes:
transmitting first configuration information to a terminal, where the first configuration information includes first security parameter(s) corresponding to at least one candidate access network device, and the first security parameter(s) include at least one of: an indication of a key derivation manner, or a first NCC.

The embodiments of the present application provide a communication method performed by a core network device, which includes:
transmitting second configuration information to a first access network device, where the second configuration information is used by the first access network device to determine first security parameter(s) corresponding to at least one candidate access network device, and the first security parameter(s) include at least one of: an indication of a key derivation manner, or a first NCC.

The embodiments of the present application provide a communication method performed by a second access network device, which includes:
receiving third configuration information from a core network device, where the third configuration information includes a second security parameter corresponding to the second access network device, and the second security parameter includes at least one of: an indication of a key derivation manner, a first NCC, or a first NH.

The embodiments of the present application provide a communication method performed by a terminal, which includes:
in a case of horizontally deriving a first security key between the terminal and a second access network device, receiving second information from the second access network device, where the second information carries a second NCC, and the second NCC is used for vertically deriving a third security key between the terminal and the second access network device.

The embodiments of the present application provides a communication method performed by a second access network device, which includes:
in a case where a horizontally derived first security key between a terminal and the second access network device is obtained, transmitting a path switch request to a core network device;
receiving a path switch response message from the core network device, where the path switch response message carries a second NCC and a second NH, and the second NH is used for vertically deriving a third security key between the second access network device and the terminal; and
transmitting second information to the terminal, where the second information carries the second NCC, and the second NCC is used by the terminal to vertically derive the third security key.

The embodiments of the present application provide a communication method performed by a core network device, which includes:
receiving a path switch request from a second access network device; and
transmitting a path switch response message to the second access network device, where the path switch response message carries a second NCC and a second NH.

The embodiments of the present application provide a terminal, which includes:
a first communication unit, configured to receive first configuration information from a first access network device, where the first configuration information includes first security parameter(s) corresponding to at least one candidate access network device, and the first security parameter(s) include at least one of: an indication of a key derivation manner, or a first NCC.

The embodiments of the present application provide a first access network device, which includes:
a second communication unit, configured to transmit first configuration information to a terminal, where the first configuration information includes first security parameter(s) corresponding to at least one candidate access network device, and the first security parameter(s) include at least one of: an indication of the key derivation manner, or a first NCC.

The embodiments of the present application provide a core network device, including:
a third communication unit, configured to transmit second configuration information to a first access network device, where the second configuration information is used by the first access network device to determine first security parameter(s) corresponding to at least one candidate access network device, and the first security parameter(s) include at least one of: an indication of the key derivation manner, or a first NCC.

The embodiments of the present application provide a second access network device, which includes:
a fourth communication unit, configured to receive third configuration information from a core network device, where the third configuration information includes a second security parameter corresponding to the second access network device, and the second security parameter includes at least one of: an indication of the key derivation manner, a first NCC, or a first NH.

The embodiments of the present application provide a terminal, which includes:
a first communication unit, configured to: in a case where a first security key between the terminal and a second access network device is horizontally derived, receive second information from the second access network device, where the second information carries a second NCC, and the second NCC is used for vertically deriving a third security key between the terminal and the second access network device.

The embodiments of the present application provide a second access network device, which includes:
a fourth communication unit, configured to:
in a case where a horizontally derived first security key between a terminal and the second access network device is obtained, transmit a path switch request to a core network device;
receive a path switch response message from the core network device, where the path switch response message carries a second NCC and a second NH, the second NH is used for vertically deriving a third security key between the second access network device and the terminal; and
transmit second information to the terminal, where the second information carries the second NCC, and the second NCC is used by the terminal to vertically derive the third security key.

The embodiments of the present application provide a core network device, which includes:
a third communication unit, configured to:
receive a path switch request from a second access network device; and
transmit a path switch response message to the second access network device, where the path switch response message carries a second NCC and a second NH.

The embodiments of the present application provide a terminal, which includes a transceiver, a processor, and a memory. The memory is configured to store a computer program, and the processor is configured to invoke the computer program stored in the memory and run the computer program, to cause the terminal to perform the above-described methods.

The embodiments of the present application provide a first access network device, which includes a transceiver, a processor, and a memory. The memory is configured to store a computer program, and the processor is configured to invoke the computer program stored in the memory and run the computer program, to cause the first access network device to perform the above-described method.

The embodiments of the present application provide a core network device, which includes a transceiver, a processor, and a memory. The memory is configured to store a computer program, and the processor is configured to invoke the computer program stored in the memory and run the computer program, to cause the core network device to perform the above-described methods.

The embodiments of the present application provide a second access network device, which includes a transceiver, a processor, and a memory. The memory is configured to store a computer program, and the processor is configured to invoke the computer program stored in the memory and run the computer program, to cause the second access network device to perform the above-described methods.

The embodiments of the present application provide a chip configured to implement the above methods.

Specifically, the chip includes a processor, which is configured to invoke a computer program from a memory and run the computer program, to cause a device equipped with the chip to perform the above-described methods.

The embodiments of the present application provides a non-transitory computer-readable storage medium configured to store a computer program which, when executed by a device, causes the device to perform the above-described methods.

The embodiments of the present application provide a computer program product, which includes computer program instructions, and the computer program instructions cause a computer to perform the above-described methods.

The embodiments of the present application provide a computer program which, when executed on a computer, causes the computer to perform the above-described methods.

### BRIEF DESCRIPTION OF THE DRAWINGS

FIG. 1 is a schematic diagram showing an application scenario according to the embodiments of the present application.

FIG. 2 is a schematic flowchart of a communication method according to an embodiment of the present application.

FIG. 3 is a schematic flowchart of a communication method according to another embodiment of the present application.

FIG. 4 is a schematic flowchart of a communication method according to yet another embodiment of the present application.

FIG. 5 is a schematic flowchart of a communication method according to still another embodiment of the present application.

FIG. 6 is a schematic diagram showing a scenario of candidate cells according to an embodiment of the present application.

FIGS. 7 and 8 are two example flowcharts of a communication method according to an embodiment of the present application.

FIGS. 9 and 10 are two schematic flowcharts showing the handover according to a communication method in an embodiment of the present application.

FIGS. 11 and 12 are two additional example flowcharts of a communication method according to an embodiment of the present application.

FIG. 13 is a schematic flowchart of a communication method according to an embodiment of the present application.

FIG. 14 is a schematic flowchart of a communication method according to another embodiment of the present application.

FIG. 15 is a schematic flowchart of a communication method according to another embodiment of the present application.

FIG. 16 is a schematic block diagram of a terminal according to an embodiment of the present application.

FIG. 17 is a schematic block diagram of a first access network device according to an embodiment of the present application.

FIG. 18 is a schematic block diagram of a core network device according to an embodiment of the present application.

FIG. 19 is a schematic block diagram of a second access network device according to an embodiment of the present application.

FIG. 20 is a schematic block diagram of a communication device according to an embodiment of the present application.

FIG. 21 is a schematic block diagram of a chip according to the embodiments of the present application.

FIG. 22 is a schematic block diagram of a communication system according to the embodiments of the present application.

### DETAILED DESCRIPTION

Technical solutions in the embodiments of the present application can be applied to various communication systems, such as a long term evolution (LTE) system, an advanced long term evolution (LTE-A) system, a new radio (NR) system, an evolution system of the NR system, a wireless local area network (WLAN), wireless fidelity (WiFi), or other communication systems.

In the embodiments of the present application, various embodiments will be described from the perspectives of a network device and a terminal. The terminal may be mobile or stationary, and may also be referred to as a mobile station, a user unit, etc. The terminal may be a device such as a station in the WLAN, or a smart terminal, a wireless modem, a laptop, or a tablet computer. In the embodiments of the present application, the terminal may be a virtual reality (VR) terminal/augmented reality (AR) terminal, a terminal in industrial control, a terminal in self-driving, a terminal in remote medical, a terminal in smart grid, a terminal in transportation safety, a terminal in smart city, or a wireless terminal in smart home, etc. As an example but not a limitation, in the embodiments of the present application, the terminal may also be a wearable device.

In the embodiments of the present application, the network device may be a device used for communicating with terminals, and the network device may be an access point in the WLAN, an evolved base station in the LTE, or a relay station, or an vehicle-mounted device, a wearable device, and a network device (gNB) in an NR network, or a network device in a future evolved PLMN network, or a network device in a non-terrestrial network, etc. As an example but not a limitation, in the embodiments of the present application, the network device may have mobile characteristics, for example, the network device may be a mobile device.

It should be understood that the terms “system” and “network” are often used interchangeably herein. The term “and/or” herein describes an association relationship between associated objects, which indicates that there may be three kinds of relationships. For example, “A and/or B” may indicate three cases where: A exists alone, both A and B exist, and B exists alone. In addition, a character “/” herein generally indicates that the associated objects before and after this character are in an “or” relationship. It should be understood that, “indicate/indicated/indicating/indication” involved in the embodiments of the present application may be a direct indication, may be an indirect indication, or may represent an association relationship. As an example, if A indicates B, it may mean that A directly indicates B, for example, B can be acquired through A; or it may mean that A indicates B indirectly, for example, A indicates C, and B can be acquired through C; or it may mean that there is an association relationship between A and B. In the description of the embodiments of the present application, the term “correspond/corresponding/correspondence” may mean that there is a direct correspondence or an indirect correspondence between two elements, or may mean that there is an association relationship between the two elements, or may mean a relationship such as indicating and being indicated, or configuring and being configured.

To facilitate understanding of the technical solutions of the embodiments of the present application, the related technologies of the embodiments of the present application will be described below. The following related technologies, as optional solutions, can be arbitrarily combined with the technical solutions of the embodiments of the present application, and theses combined solutions all fall within the protection scope of the embodiments of the present application.

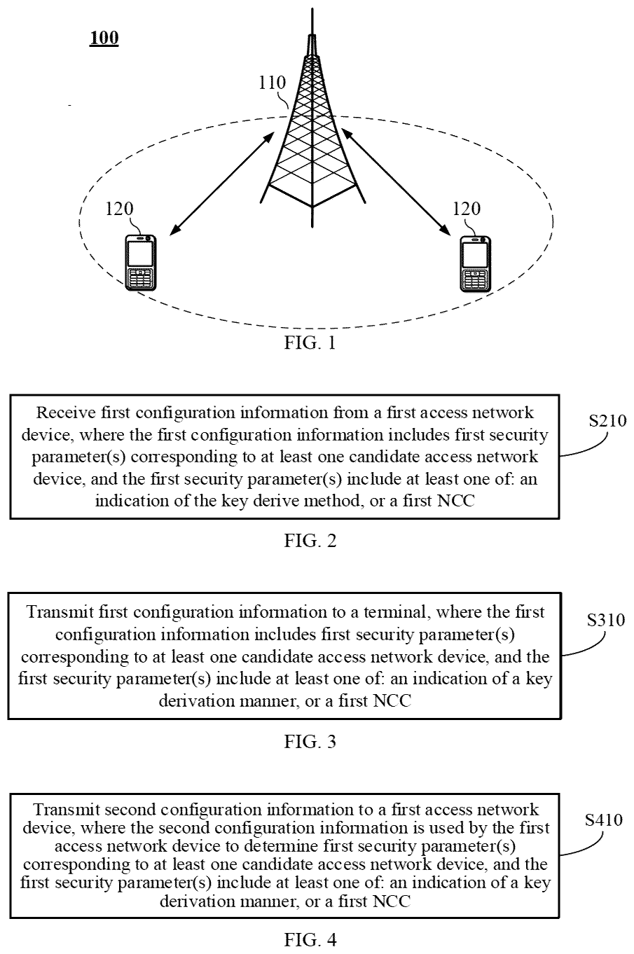

FIG. 1 exemplarily shows a communication system 100. The communication system includes a network device 110 and two terminals 120. In one possible implementation, the communication system 100 may include multiple network devices 110, and within the coverage area of each network device 110, there may be another quantity of terminal devices 120, which is not limited in the embodiments of the present application. In one possible implementation, the communication system 100 may further include other network entities such as a mobility management entity, and an access and mobility management function, which are not limited in the present application embodiment. The network device may further include an access network device and a core network device. That is, the communication system may further include multiple core networks for communicating with the access network device. The access network device may be a base station in an LTE, LTE-A, or NR system. Taking the communication system shown in FIG. 1 as an example, the communication device may include a network device with a communication function and a terminal device with a communication function. The communication device may also include other devices in the communication system, e.g., a network entity such as a network controller, or a mobility management entity, which are not limited in the embodiments of the present application.

FIG. 2 is a schematic flowchart of a communication method performed by a terminal according to an embodiment of the present application. The method includes at least some of the following content.
In S210, first configuration information is received from a first access network device, where the first configuration information includes at least one corresponding first security parameter, and the first security parameter includes at least one of: an indication of the key derive method, or a first next hop chaining counter (NCC).

FIG. 3 is a schematic flowchart of a communication method performed by a first access network device according to another embodiment of the present application. The method includes at least some of the following content.
In S310, first configuration information is transmitted to a terminal, where the first configuration information includes first security parameter(s) corresponding to at least one candidate access network device, and the first security parameter(s) include at least one of: an indication of a key derivation manner, or a first NCC.

FIG. 4 is a schematic flowchart of a communication method performed by a core network device according to another embodiment of the present application. The method includes at least some of the following content.
In S410, second configuration information is transmitted to a first access network device, where the second configuration information is used by the first access network device to determine first security parameter(s) corresponding to at least one candidate access network device, and the first security parameter(s) include at least one of: an indication of a key derivation manner, or a first NCC.

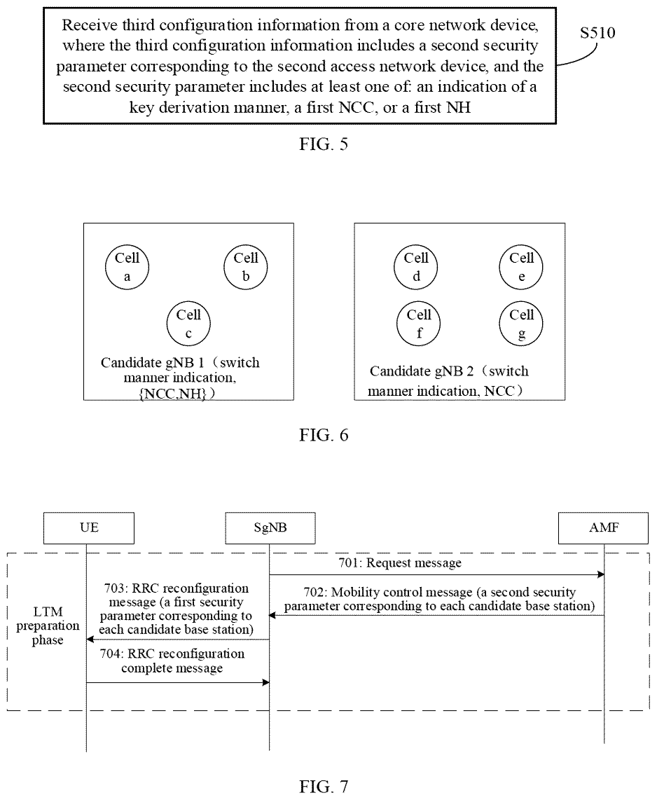

FIG. 5 is a schematic flowchart of a communication method performed by a second access network device according to another embodiment of the present application. The method includes at least some of the following content.
In S510, third configuration information is received from a core network device, where the third configuration information includes a second security parameter corresponding to the second access network device, and the second security parameter includes at least one of: an indication of a key derivation manner, a first NCC, or a first next hop key (NH).

The at least one candidate access network device refers to one or more candidate access network devices of a terminal.

The first access network device may be the access network device currently connected to the terminal, and/or the access network device currently providing services to the terminal. The second access network device is a target access network device to which the terminal is going to hand over during the handover procedure, and the second access network device is one of the one or more candidate access network devices of the terminal.

In the following embodiments, the first access network device may be alternatively referred to as a source base station, or a source gNB, or an SgNB, or a gNB; the second access network device may be alternatively referred to as a target base station, or a target gNB, or a TgNB; and the candidate access network device may be alternatively referred to as a candidate gNB, or a candidate base station.

The core network device may be a control plane node (or a network element) on the core network side. For example, the core network device may include an AMF. This is merely an illustrative description, and the core network device is not limited or exhaustively listed in this embodiment.

The NH may be alternatively referred to as a next hop parameter, etc., and all possible names of it are not limited or exhaustively listed here.

In some possible implementations, the processing of the first access network device may further include: receiving second configuration information from the core network device, where the second configuration information is used for determining first security parameter(s) corresponding to the at least one candidate access network device. The second configuration information is transmitted before the first access network device transmits the first configuration information to the terminal. Here, the first security parameter(s) corresponding to at least one candidate access network device may refer to a first security parameter corresponding to each candidate access network device in the at least one candidate access network device.

In one embodiment, the processing of the first access network device may further include: transmitting a request message to the core network device, where the request message is used to request allocation of the second configuration information. Accordingly, the processing of the core network device may further include: receiving the request message from the first access network device, where the request message is used to request allocation of the second configuration information. Here, the transmission timing of the request message may be prior to the transmission of the second configuration information.

The request message may be transmitted to the core network device during any interaction between the first access network device and the core network device.

Optionally, the source gNB may transmit the request message to the core network device during or before the handover preparation phase. The handover preparation phase may be an LTM preparation phase, an inter LTM handover preparation phase, an inter-CU LTM handover preparation phase, or a preparation phase for other handover procedures, which will not be limited or exhaustively listed here.

Optionally, the source gNB may transmit the request message to the core network device during a path switch phase. The path switch phase may refer to a path switch phase after the terminal hands over from another gNB to the source gNB (e.g., after completing the inter-CU LTM handover), and the request message may be a path switch request during the path switch phase.

Alternatively, considering the delay caused by the interaction between the source gNB and the AMF, for the inter-CU LTM, only vertical key derivation is performed by default. For example, the request message may be used during any interaction between the source gNB and the AMF to request a second security parameter corresponding to each candidate gNB, which includes {first NH, first NCC}.

Optionally, the second configuration information may be transmitted from the AMF to the source gNB during or before the handover preparation phase of the source gNB. For example, the second configuration information may be carried in a mobility control message.

Optionally, the second configuration information may be transmitted from the AMF to the source gNB during the path switch phase of the source gNB. For example, the second configuration information may be carried in a path switch response message.

In one embodiment, it is not required for the first access network device to transmit a request message to the core network device; instead, the core network device determines and transmits the second configuration information to the first access network device. The method for transmitting the second configuration information is the same as that described in the foregoing embodiments, which will not be repeated here.

In some possible implementations, the second configuration information includes at least one of: second security parameter(s) corresponding to the at least one candidate access network device; a second security parameter corresponding to each second candidate access network device, where the each second candidate access network device is a candidate access network device, among the at least one candidate access network devices, that is not configured with a second security parameter; or one or more NCCs and an NH corresponding to each NCC, where the each NCC and its corresponding NH are used for determining the second security parameter(s) corresponding to the at least one candidate access network device.

Here, the second security parameter(s) corresponding to at least one candidate access network device may refer to the second security parameter corresponding to each candidate access network device in the at least one candidate access network device.

A second security parameter includes at least one of: an indication of a key derivation manner, a first NCC, or a first NH. For example, the second security parameter corresponding to any candidate gNB may include at least one of: an indication of a key derivation manner corresponding to the candidate gNB, a first NCC corresponding to the candidate gNB, or a first NH corresponding to the candidate gNB.

The indication of the key derivation manner includes one of: an indication of vertical key derivation, an indication of horizontal key derivation. In some possible examples, the indication of vertical key derivation may be alternatively referred to as a vertical key switch indication or a vertical switch indication; and the indication of the horizontal key derivation may be alternatively referred to as a horizontal key switch indication, or a horizontal switch indication, etc.

In some possible implementations, the second configuration information includes the second security parameter(s) corresponding to the at least one candidate access network device, where the second security parameter(s) corresponding to the at least one candidate access network device are used for determining the first security parameter corresponding to the at least one candidate access network device.

Each candidate access network device of the terminal is determined by the first access network device, the first access network device indicates each candidate access network device of the terminal to the core network device via the request message. The request message may carry at least one of: an identifier of each candidate access network device, or an identifier of each candidate cell in one or more candidate cells corresponding to each candidate access network device. The identifier of each candidate cell may include at least one of: a cell ID of each candidate cell, or a physical cell identifier (PCI) of each candidate cell.

The processing of the core network device may further include: determining a key derivation manner of each candidate access network device; and determining a first NCC corresponding to each candidate access network device and/or a first NH corresponding to each candidate access network device based on the key derivation manner of each candidate access network device.

The determination of the key derivation manner of each candidate access network device performed by the core network device may be determining the key derivation manner of each candidate access network device based on a local policy and/or the content carried in the request message. Here, in addition to the content mentioned in the foregoing embodiments, the content carried in the request message may also include other relevant configurations of each candidate access network device and/or each candidate cell, which is not limited in this embodiment.

In an example where any candidate access network device is the i-th candidate gNB, the core network device determines the first NCC corresponding to each candidate access network device and/or the first NH corresponding to each candidate access network device in one of the following ways: in a case where the i-th candidate gNB corresponds to vertical key derivation, determining that the first NCC corresponding to the i-th candidate gNB is greater than the NCC corresponding to the second security key between the terminal and the source gNB, and calculating the first NH corresponding to the i-th candidate gNB; in a case where the i-th candidate gNB corresponds to the horizontal key derivation, determining that the first NCC corresponding to the i-th candidate gNB is equal to the NCC corresponding to the second security key, where i is a positive integer.

Here, calculating the first NH corresponding to the i-th candidate gNB may be: vertically deriving the first NH corresponding to the i-th candidate gNB based on the first key (K_{AMF}) shared between the terminal and the AMF and a previously derived key. The number of times the derivation calculations performed for the vertical derivation of the first NH may be equal to the difference between the first NCC corresponding to the i-th candidate gNB and the NCC corresponding to the second security key. The previously derived key may include an initial K_{gNB} corresponding to the terminal or a previously derived NH.

In a case where the key derivation manner corresponding to the i-th candidate gNB is vertical key derivation, the second security parameter corresponding to the i-th candidate gNB may include: the first NCC corresponding to the i-th candidate gNB, and the first NH corresponding to the i-th candidate gNB. It should be noted that the second security parameter corresponding to the i-th candidate gNB may or may not include an indication of vertical key derivation.

In a case where the key derivation manner corresponding to the i-th candidate gNB is horizontal key derivation, the second security parameter corresponding to the i-th candidate gNB may include: an indication of the horizontal key derivation corresponding to the i-th candidate gNB and/or the first NCC corresponding to the i-th candidate gNB.

Since the relevant descriptions for the second security parameter corresponding to each candidate access network device are the same as those for the i-th candidate gNB, they will not be repeated here.

Taking the i-th candidate gNB as an example, the first access network device determines the first security parameter corresponding to each candidate access network device based on the second security parameter corresponding to each candidate access network device, which may include one of the following: in a case where the second security parameter corresponding to the i-th candidate gNB includes the first NH and first NCC corresponding to the i-th candidate gNB, determining the first NCC corresponding to the i-th candidate gNB as the first security parameter corresponding to the i-th candidate gNB; in a case where the second security parameter corresponding to the i-th candidate gNB includes the first NH corresponding to the i-th candidate gNB, the first NCC corresponding to the i-th candidate gNB, and the indication of vertical key derivation corresponding to the i-th candidate gNB, determining the first NCC corresponding to the i-th candidate gNB as the first security parameter corresponding to the i-th candidate gNB, or determining the first NCC corresponding to the i-th candidate gNB and the indication of vertical key derivation corresponding to the i-th candidate gNB as the first security parameter corresponding to the i-th candidate gNB; in a case where the second security parameter corresponding to the i-th candidate gNB includes the first NCC corresponding to the i-th candidate gNB and/or the indication of horizontal key derivation corresponding to the i-th candidate gNB, determining the first NCC corresponding to the i-th candidate gNB and/or the indication of horizontal key derivation corresponding to the i-th candidate gNB as the first security parameter corresponding to the i-th candidate gNB. The relevant generation method for the first security parameter corresponding to each candidate access network device is the same as that for the i-th candidate gNB, and therefore will not be repeated.

In some possible implementations, the second configuration information includes a second security parameter corresponding to each second candidate access network device.

In a case where the first access network device determines that at least some of the one or more candidate access network devices of the terminal are not configured with the second security parameter, all the candidate access network devices not configured with second security parameters are determined as second candidate access network devices of the terminal, and a request message is transmitted to the core network device to indicate each second candidate access network device of the terminal which is not configured with the second security parameter. Specifically, the request message may carry at least one of: an identifier of each second candidate access network device, or an identifier of each candidate cell corresponding to each second candidate access network device.

Additionally, the following processing may be included: in a case where the first access network device determines that among the one or more candidate access network devices of the terminal, there are one or more candidate access network devices that are not configured with second security parameter(s), determining the candidate access network device(s) that are not configured with the second security parameter(s) as fourth candidate access network device(s) of the terminal.

Here, a candidate access network device that is not configured with the second security parameter refers to one for which the first access network device has not configured or stored its second security parameter corresponding to the terminal. A candidate access network device that is configured with the second security parameter refers to one for which the first access network device has configured or stored its second security parameter corresponding to the terminal. The configured second security parameter(s) may be transmitted by the previous source access network device of the terminal when the first access network device serves as the target access network device in the previous handover of the terminal.

In this embodiment, the processing of the core network device for determining the second security parameter corresponding to each second candidate access network device is similar to that in the foregoing embodiments. Therefore, it is only necessary to regard any second candidate access network device as the i-th candidate gNB in the foregoing embodiments, and thus no repeated descriptions will provided here.

After the first access network device receives the second configuration information, the following processing may be included: based on the second security parameter corresponding to each second candidate access network device, determining the second security parameter corresponding to each candidate access network device; and based on the second security parameter corresponding to each candidate access network device, determining the first security parameter corresponding to each candidate access network device.

Here, determining the second security parameter corresponding to each candidate access network device based on the second security parameter corresponding to each second candidate access network device may include: determining the second security parameter corresponding to each second candidate access network device and the second security parameter corresponding to each fourth candidate access network device as the first security parameter corresponding to each candidate access network device.

In some possible implementations, in a case where the first access network device determines that all of the one or more candidate access network devices of the terminal are configured with the second security parameters, it is unnecessary to transmit a request message to the core network device. Instead, the first access network device can directly determine the first security parameter corresponding to each candidate access network device based on the second security parameter corresponding to each candidate access network device.

The processing of the first access network device may further include: based on the {first NH, first NCC} or first NCC corresponding to each candidate access network device, determining a key derivation manner corresponding to each candidate access network device. Taking the i-th candidate gNB as an example, if the i-th candidate gNB is configured with an unused first NCC value, the switch manner corresponding to the i-th candidate gNB is vertical switch (i.e., vertical key derivation). If the first NCC configured for the i-th candidate gNB is equal to the NCC value corresponding to the second security key, the switch manner corresponding to the i-th candidate gNB is horizontal switch. Considering security, it may be specified that in a case where a new set {first NH, first NCC} exists, the source gNB must use the new first NCC as the first security parameter corresponding to the candidate gNB.

In some possible implementations, the second configuration information includes one or more NCCs and an NH corresponding to each NCC.

In this implementation, the first access network device may transmit a request message to the core network device to request the core network device to allocate second configuration information; alternatively, the first access network device may not transmit the request message to the core network device, which is not limited in this embodiment.

The processing for the core network device to determine the second configuration information may include: determining that a value of each NCC in the one or more NCCs is greater than the NCC corresponding to the second security key, and calculating an NH corresponding to each NCC; and adding each NCC and its corresponding NH into the second configuration information. The method for calculating the NH corresponding to each NCC is similar to the method for calculating any first NH described in the foregoing embodiments, and will not be repeated here.

The processing of the first access network device after receiving the second configuration information may include: determining the second security parameter corresponding to each candidate access network device based on the second configuration information; and based on the second security parameter corresponding to each candidate access network device, determining the first security parameter corresponding to each candidate access network device. The processing for determining the first security parameter corresponding to each candidate access network device based on the second security parameter corresponding to each candidate access network device is the same as that in the foregoing embodiments, and thus will not be repeated here.

Exemplarily, determining, by the first access network device, the second security parameter corresponding to each candidate access network device based on the second configuration information may include: assigning each NCC and its corresponding NH to each candidate gNB to obtain the first NCC and first NH corresponding to each candidate gNB, where different first NCCs correspond to different candidate gNBs; or, assigning each NCC and its corresponding NH to each candidate gNB to obtain the first NCC and first NH corresponding to each candidate gNB, and if there remain candidate gNBs to which no NCC or NH is assigned, determining horizontal key derivation as the key derivation manner for these candidate gNBs to which no NCC or NH is assigned, and determining the NCC corresponding to the second security key as their corresponding first NCCs. It should be understood that the above are merely illustrative examples, and all possible methods are not exhaustively listed here.

In the scenarios involved in the foregoing implementations, where the core network device (AMF) decides and configures the second security parameters, it may be controlled that only horizontal key derivation or only vertical key derivation is performed during the AMF makes decisions for the inter-CU LTM of UE.

The aforementioned first configuration information may be carried in an access stratum (AS) message. For example, the first configuration information may be carried in an RRC message; as another example, the RRC message may be an RRC reconfiguration message carrying LTM candidate configuration (or LTM candidate cell configuration).

Illustrative descriptions will be provided with reference to FIG. 6. The second configuration information transmitted by the AMF to the SgNB includes a second security parameter pre-configured for each candidate gNB. The second security parameter includes at least one of: a first NCC, a first NH, or an indication of the switch manner (i.e., an indication of the key derivation manner). The second security parameters are at the gNB granularity, not at the cell granularity. As shown in FIG. 6, the UE has multiple candidate cells, namely Cell a to Cell g in FIG. 6, and these candidate cells belong to candidate gNB1 or candidate gNB2. If it is determined that vertical key derivation is to be used for the handover of UE from SgNB to candidate gNB1, the second configuration information transmitted by the AMF to the candidate SgNB includes {NCC, NH} corresponding to candidate gNB1, and may also include an indication of vertical key derivation. If it is determined that horizontal key derivation is to be used for the handover of UE from the SgNB to candidate gNB2, the second configuration information transmitted by the AMF to the SgNB includes an NCC corresponding to candidate gNB2 and an indication of horizontal key derivation.

The first security parameter of each candidate gNB that is pre-configured for the UE by the SgNB includes: a first NCC and/or an indication of a key derivation manner. The UE determines whether to perform horizontal switch or vertical switch based on the first security parameter of each candidate gNB pre-configured by the SgNB. For example, if the first security parameter of a candidate gNB is only configured with a first NCC, and the first NCC of the candidate gNB is greater than the NCC corresponding to the second security key, it indicates that vertical derivation is to be performed. If the first NCC of the candidate gNB is equal to the NCC corresponding to the second security key, it indicates that horizontal derivation is to be performed. It should be noted that the security parameters configured for the UE are also at the gNB granularity, that is, candidate cells belonging to the same gNB share the same security configuration. Once the UE performs a key update using the security configuration of a candidate cell, the security parameters of other candidate cells belonging to the same gNB are no longer used.

With reference to FIG. 7, an exemplary description will be provided through an example where the SgNB obtains the security parameters via the interaction with the AMF before the inter-LTM handover, or during the inter-LTM handover preparation phase, or during the LTM preparation phase. Specifically:
In Step 701, the SgNB transmits a request message to the AMF, and the request message may carry: identifiers of candidate cells and identifiers of candidate base stations to which the candidate cells belong;
In Step 702, the AMF provides a mobility control message to the SgNB, where the mobility control message carries second configuration information. Specifically, the mobility control message carries a second security parameter corresponding to each candidate base station. The mobility control message may be provided during the establishment of the connection between the SgNB and the AMF or during the last TA update (update timing advance (TA)).
In Step 703, the SgNB transmits an RRC reconfiguration message to the UE. The RRC reconfiguration message may be the LTM candidate cell configuration, which includes a first security parameter corresponding to each candidate base station.
In Step 704, the UE transmits an RRC reconfiguration complete message to the SgNB to indicate that the configuration is complete.

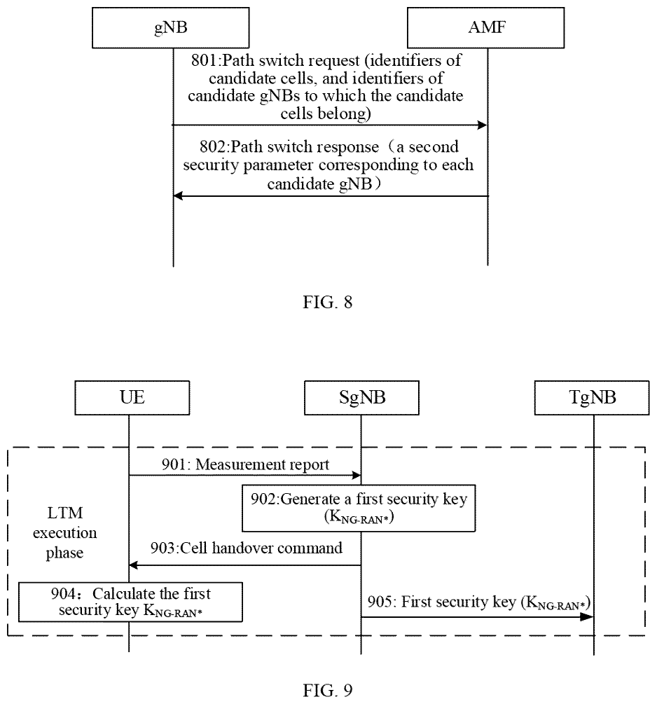

In one example, during the path switch phase (or procedure), the gNB interacts with the AMF to obtain the second security parameter corresponding to each candidate base station. During the LTM preparation phase, the first security parameter corresponding to each candidate base station is configured for the UE through the RRC signaling carrying the LTM candidate configuration. That is, after the UE handovers to the target base station, the target base station as the base station connected to the UE (i.e., the gNB in FIG. 8) obtains security parameters for the potential subsequent inter-CU LTM handover of the UE during its interaction with the AMF. The handover here may refer to an L3-based handover or an LTM procedure. Referring to FIG. 8, the above procedure specifically includes the following steps.
In Step 801, when the gNB transmits a path switch request to the AMF, the gNB triggers the AMF to switch the DL data path to itself and establish an NG-C interface. The path switch request may include candidate configuration information of the UE, such as identifiers of candidate cells, and identifiers of candidate gNBs to which the candidate cells belong.
In Step 802, the AMF decides whether vertical key derivation or horizontal key derivation is to be used when the UE hands over to a candidate cell, based on a local policy or inter-CU LTM candidate configuration information of the UE provided by the SgNB, and the AMF transmits a path switch response to the gNB, which carries second configuration information, that is, a second security parameter corresponding to each candidate gNB.
After Step 802 is completed, the gNB may transmit first configuration information to the UE during any interaction with the UE. The related processing is similar to Step 703 and Step 704 in FIG. 7, and thus will not be repeated here.

In some possible implementations, the processing performed by the terminal may further include: receiving a cell handover command which is used to indicate a target cell; based on a second access network device to which the target cell belongs and the first configuration information, determining a first security parameter corresponding to the second access network device which is one of the at least one candidate access network device; and calculating the first security key between the terminal and the second access network device based on the first security parameter corresponding to the second access network device.

The processing performed by the first access network device may further include: based on the second security parameter corresponding to the second access network device to which the target cell corresponding to the terminal belongs, calculating the first security key between the terminal and the second access network device, where the second access network device is one of the at least one candidate access network device; and transmitting first information to the second access network device, which includes: the first security key, and an NCC corresponding to the first security key.

The processing of the second access network device may further include: receiving the first information from the first access network device.

Before the terminal receives the cell handover command, the following processing may be further included: transmitting a measurement report to the first access network device. Correspondingly, the way for the first access network device to determine the target cell may include: receiving a measurement report from the terminal, and determining the target cell corresponding to the terminal based on the measurement report. The measurement report may be a Layer 1 (L1) and/or Layer 2 (L2) measurement report. This embodiment does not impose limitation to the content included in the measurement report or the way for the first access network device to determine the target cell.

For example, calculating, by the first access network device based on the second security parameters corresponding to the second access network device to which the target cell corresponding to the terminal belongs, the first security key between the terminal and the second access network device may refer to: in a case where the second security parameter corresponding to the TgNB to which the target cell corresponding to the terminal belongs include a first NCC and a first NH, deriving the first security key based on the first NH; in a case where the second security parameter corresponding to the TgNB to which the target cell corresponding to the terminal belongs includes a first NCC and/or an indication of horizontal key derivation, horizontally deriving the first security key based on second security key. Furthermore, after the calculation of the first security key, the following processing may be further included: determining the first NCC in the second security parameter corresponding to the TgNB as the NCC corresponding to the first security key.

Receiving, by the terminal, the cell handover command may include one of the following: receiving a cell handover command from the first access network device; or receiving a cell handover command from the second access network device. The cell handover command may be carried in a MAC CE.

In one example, before or after the first access network device transmits the first information to the second access network device, the following processing may be further included: transmitting a cell handover command to the terminal. In one example, the processing by the second access network device after receiving the first information from the first access network device may include: transmitting a cell handover command to the terminal.

For example, the processing of the terminal for calculating a first security key between the terminal and the second access network device based on the first security parameter corresponding to the second access network device may include: in a case where the first security parameter corresponding to the TgNB includes a first NCC and the first NCC is greater than an NCC corresponding to a second security key, or in a case where the first security parameter corresponding to the TgNB includes a first NCC and an indication of vertical key derivation, vertically deriving a first NH based on the first NCC, and calculating the first security key based on the first NH; in a case where the first security parameter corresponding to the TgNB includes a first NCC and the first NCC is equal to the NCC corresponding to the second security key, or in a case where the first security parameter corresponding to the TgNB includes an indication of horizontal key derivation, or in a case where the first security parameter corresponding to the TgNB includes a first NCC and an indication of horizontal key derivation, horizontally deriving the first security key based on the second security key. The second security key may be denoted as K_{gNB}-1, and the first security key may be denoted as K_{NG-RAN} or K_{NG-RAN*}. When the terminal derives the first security key, other radio parameters, such as a cell ID (PCI) and downlink frequency, may also be used, which are not limited here.

In some embodiments, in scenarios where the second configuration information includes second security parameters corresponding to candidate access network devices or second security parameters corresponding to second candidate access network devices, the first configuration information provided by the SgNB to the UE includes a first security parameter corresponding to each candidate gNB. For example, the candidate gNBs include candidate gNB1 and candidate gNB2. When the UE hands over to TgNB (e.g., candidate gNB1) via LTM, the TgNB, acting as the new gNB connected to the UE, transmits a new request message to the AMF to obtain second security parameters corresponding to new candidate gNBs. For example, the new candidate gNBs may still include candidate gNB2. In this case, both TgNB and SgNB may be configured with candidate cells belonging to the same candidate gNB2, which can potentially lead to a conflict in security parameter configuration. To avoid the reverse-order use of {NH, NCC} pairs, the AMF always increments the NCC value and calculates the new NH value before providing them to the gNB currently connected to the UE (unless the NCC has reached its maximum value). For the gNB side and the UE side, there may be several possible solutions to resolve the issue, which will be discussed below.

Optionally, on the first access network device side, after the first access network device transmits the first information to the second access network device, the method further includes: deleting the second security parameter corresponding to each candidate access network device. For example, after the UE completes a handover procedure, it deletes the relevant security parameters and does not transmit unused {first NH, first NCC} to the TgNB.

Optionally, on the first access network device side, after receiving the second configuration information from the core network device, the method further includes: if historical security parameter(s) of third candidate access network device(s) among the terminal's one or more candidate access network devices which correspond to the terminal are stored, deleting the historical security parameter(s) of the third candidate access network device(s) that correspond to the terminal. The number of the third candidate access network device(s) may be one or more.

Optionally, the first information may further include one of the following: a second security parameter corresponding to an unused candidate access network device; or a second security parameter corresponding to a candidate access network device whose first NCC is greater than the NCC corresponding to the first security key.

In other words, after calculating the first security key, the SgNB may determine whether it still stores configured but unused second security parameters corresponding to candidate gNBs. If such parameters exist, the SgNB further determines whether a first NCC corresponding to an unused second security parameter corresponding to a candidate gNB is greater than the NCC corresponding to the first security key, and if there exist second security parameters corresponding to candidate gNBs of the terminal whose first NCCs are greater than the NCC corresponding to the first security key, the SgNB adds these second security parameters corresponding to such candidate gNBs to the first information and transmits the information to the TgNB. For example, after the UE completes a handover procedure, the UE updates the first security key based on a certain NCC value; the SgNB may delete other first NCCs smaller than the NCC value and their corresponding first NHs, and retains only the {first NH, first NCC} pairs with NCC values larger than the NCC value and transmits them to the TgNB.

In this way, when the TgNB serves as the source gNB in the next handover, it may request from the AMF only the second security parameters for the remaining candidate gNBs that are not configured with the second security parameters. The processing in which the TgNB, acting as the source gNB in the next handover, requests the second security parameters for the candidate gNBs not configured with second security parameters is similar to the processing in the foregoing embodiments where the first access network device requests parameters for the candidate access network devices not configured with second security parameters, and will not be repeated here.

Optionally, after calculating the first security key, the first access network device may determine whether it still stores configured but unused second security parameters corresponding to candidate access network devices. If such parameters exist, the first access network device adds these second security parameters corresponding to the candidate access network devices of the terminal to the first information and transmits the information to the second access network device.

Optionally, on the terminal side: after calculating the first security key based on the first security parameter corresponding to the second access network device, the method further includes one of the following: deleting the first security parameter(s) corresponding to the at least one candidate access network device; deleting a first security parameter corresponding to a candidate access network device whose first NCC is less than the NCC corresponding to the first security key. For example, after calculating the first security key this time, the UE may delete the all configurations related to first security parameters and only receive new first security parameters. In other words, the UE uses only the first security parameters configured by the current gNB to perform the next handover. Alternatively, after completing a handover, the UE deletes the first security parameters less than the currently used NCC value.

Optionally, on the terminal side, after receiving the first configuration information from the first access network device, the method further includes: in a case where a historical security parameter corresponding to a first candidate access network device of the at least one candidate access network device is stored, deleting the historical security parameter corresponding to the first candidate access network device. In other words, for the same candidate gNB/candidate cell, when the UE receives a new first security parameter, the UE deletes the old security parameter and uses only the new first security parameter to perform the next handover. The number of such first candidate gNB(s) may be one or more.

An exemplary description will be provided with reference to FIG. 9, which specifically includes:
In Step 901, the UE transmits a measurement report to the SgNB. The measurement report may be an L1/L2 measurement report or referred to as an L1 measurement report.
In Step 902, the SgNB updates the key in a horizontal or vertical manner based on a second security parameter corresponding to the TgNB to which the target cell belongs, so as to generate a first security key K_{NG-RAN*}.
In Step 903, the SgNB transmits a cell handover command carried in a MAC CE to the UE to trigger a handover procedure. The cell handover command includes a candidate configuration index, and the index indicates to which candidate configured cell (i.e., the target cell) the UE should hands over.
In Step 904, the UE calculates the first security key K_{NG-RAN*} corresponding to the target cell (or the TgNB to which it belongs), based on a first NCC and/or an indication of key derivation manner in the first security parameter corresponding to the TgNB to which the target cell belongs.
In Step 905, after calculating the first security key K_{NG-RAN*}, the SgNB transmits the first security key K_{NG-RAN*} and the corresponding NCC value to the TgNB. Correspondingly, the TgNB uses the first security key K_{NG-RAN*} as the KgNB to establish security with the UE. Step 905 can be executed after Step 902.

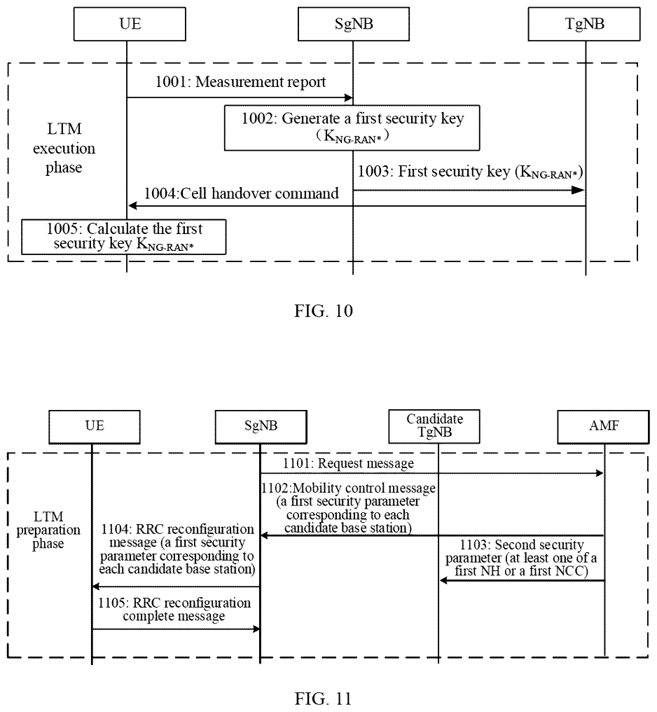

Another exemplary description will be provided with reference to FIG. 10, which specifically includes:
Step 1001 and Step 1002 are the same as Step 901 and Step 902, and will not be repeated here.
In Step 1003, after calculating the first security key K_{NG-RAN*}, the SgNB transmits the first security key K_{NG-RAN*} and the corresponding NCC value to the TgNB.
In Step 1004, the TgNB transmits a cell handover command to the UE. The cell handover command is transparently forwarded to the UE by the SgNB.
Step 1005 is the same as Step 904, and will not be repeated here.
In Step 905 or Step 1003, in a case where the AMF has configured multiple {first NH, first NCC} pairs for the SgNB, the SgNB may also transmit the unused or remaining {first NH, first NCC} pairs to the TgNB.

In some possible implementations, the second configuration information includes first security parameter(s) corresponding to the at least one candidate access network device.

The processing of the core network device further includes: transmitting third configuration information to the at least one candidate access network device, where the third configuration information corresponding to each candidate access network device includes the second security parameter corresponding to the candidate access network device. In an example where any candidate access network device is a second access network device, the second access network device can receive the third configuration information from the core network device.

In this implementation, each candidate access network device of the terminal may be determined by the first access network device. The specific determination method is the same as that described in the foregoing embodiments and will not be repeated. The manner in which the core network device determines the key derivation manner for each candidate access network device, as well as the manner in which the core network device determines the first NCC and/or first NH corresponding to each candidate access network device, is the same as those described in the foregoing embodiments and will not be repeated here.

After the first access network device receives the second configuration information from the core network device, the following processing may be included: adding the first security parameter corresponding to each candidate access network device included in the second configuration information to the first configuration information.

In this embodiment, regarding the method and messages used for transmitting the first configuration information, the request message, and the second configuration information, the descriptions are the same as that in the foregoing embodiments, and will not be repeated here.

The processing performed by the first access network device may further include: transmitting first information to the second access network device to which the target cell corresponding to the terminal belongs. The first information is used to indicate the second access network device to calculate a first security key between the second access network device and the terminal, and the second access network device is one of the one or more candidate access network devices.

The processing of the second access network device may further include: receiving the first information from the first access network device, which is used to indicate the second access network device to calculate the first security key between itself and the terminal; and calculating the first security key based on the second security parameter. The handover procedure performed by the terminal is the same as that described in the foregoing embodiments, and will not be repeated here.

The processing of the terminal for exchanging the measurement report with the first access network device before the terminal receives the cell handover command, as well as the processing of the first access network device for determining the target cell, is the same as that described in the foregoing embodiments and will not be repeated here.

The first information may also indicate the target cell. Optionally, the first information may include at least one of: a second security key between the first access network device and the terminal, or an NCC corresponding to the second security key.

The calculating, by the second access network device, the first security key based on the second security parameter may refer to: in a case where the second security parameter includes a first NCC and a first NH, deriving the first security key based on the first NH; in a case where the second security parameter includes a first NCC and/or an indication of horizontal key derivation, horizontally deriving the first security key based on the second security key included in the first information.

With references to FIG. 11, an exemplary description will be provided based on the configurations performed during the inter LTM handover preparation phase or the LTM preparation configuration procedure, which specifically includes:
Step 1101 is the same as Step 701 and will not be repeated here.
In Step 1102, the AMF provides a mobility control message to the SgNB. The mobility control message carries second configuration information. Specifically, the mobility control message carries a first security parameter corresponding to each candidate base station.
In Step 1103, the AMF transmits the corresponding second security parameter to each candidate TgNB. The second security parameter may include at least one of a first NH or a first NCC. For simplicity, FIG. 11 illustrates only one candidate TgNB, which does not impose limitation to the number of candidate TgNBs.
Step 1104 and Step 1105 are the same as Step 703 and Step 704 in FIG. 7, and will not be repeated here.

This example takes forward security into consideration. In the case where security parameters are configured for the SgNB, since the SgNB can obtain the NH (which may be regarded as an intermediate key) to be used by the UE in its next several handovers, the SgNB can obtain the key KgNB between the UE and the target base station after the next several handovers. Therefore, to ensure the forward security, a method is considered where the AMF configures the NH for the candidate base stations, and the AMF returns first security parameters excluding the NH to the SgNB.

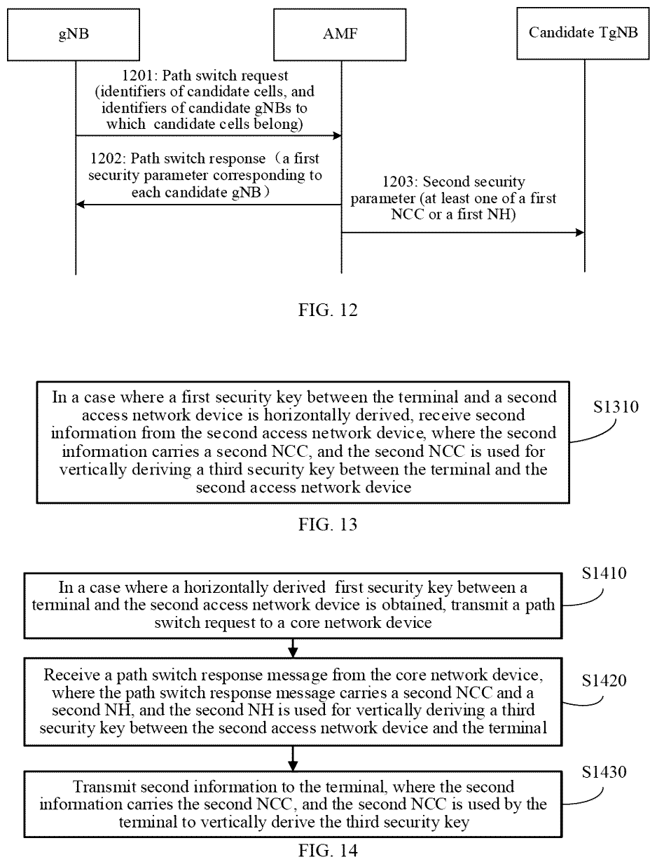

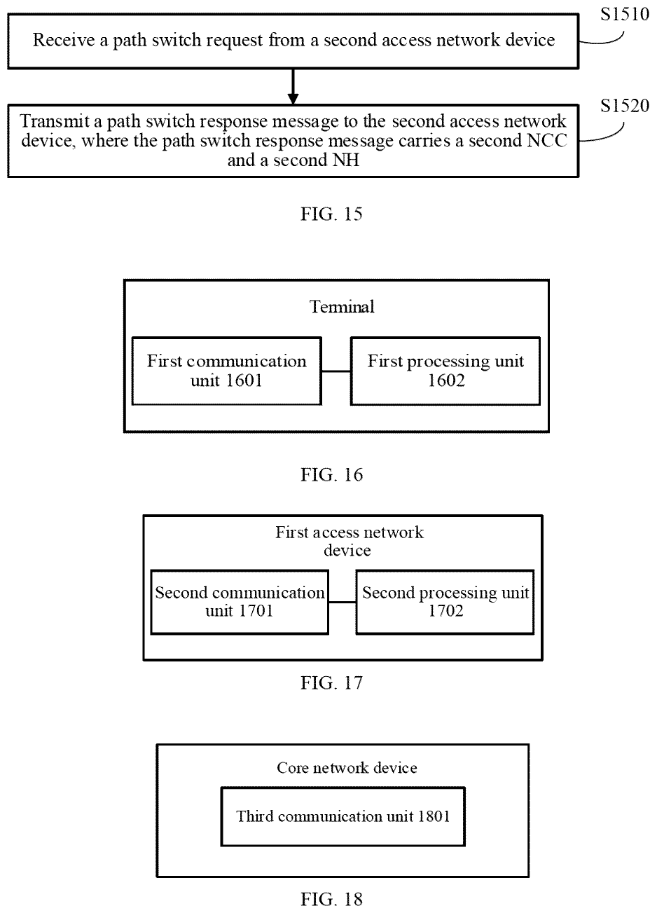

With reference to FIG. 12, an exemplary description will be provided based on the configuration method during the path switch phase (or procedure), which specifically includes:
Step 1201 is the same as Step 801 and will not be repeated here.
In Step 1202, the AMF decides whether vertical key derivation or horizontal key derivation is to be used when the UE hands over to a candidate cell, based on a local policy or inter-CU LTM candidate configuration information of the UE provided by the SgNB, and the AMF transmits a path switch response to the gNB, which carries second configuration information, that is, a first security parameter corresponding to each candidate gNB.
After Step 1202 is completed, the gNB may transmit the first configuration information, i.e., a first security parameter corresponding to each candidate TgNB, to the UE during any interaction with the UE. The related processing is similar to Step 703 and Step 704, and thus will not be repeated here.
In Step 1203, the AMF transmits the corresponding second security parameter to each candidate TgNB. The second security parameter may include at least one of a first NH or a first NCC. For simplicity, FIG. 12 illustrates only one candidate TgNB, which does not impose limitation to the number of candidate TgNBs.

In some possible implementations, the first security parameter(s) corresponding to the at least one candidate access network device are determined by the first access network device. This implementation does not require decision-making or interaction by the core network device.

Specifically, the indication of the key derivation manner is an indication of horizontal key derivation, and the first NCC is an NCC corresponding to the second security key between the first access network device and the terminal. The processing performed by the first access network device may further include: horizontally deriving a first security key between the terminal and the second access network device based on the second security key, where the second access network device corresponds to the target cell of the terminal; and transmitting first information to the second access network device, where the first information includes: the first security key, or an NCC corresponding to the first security key, and the NCC corresponding to the first security key is equal to the NCC corresponding to the second security key. The processing of the second access network device may further include: receiving the first information from the first access network device.

That is, the first security parameter corresponding to each candidate access network device may include: an indication of horizontal key derivation corresponding to the candidate access network device and/or the first NCC corresponding to the candidate access network device, where the first NCC is equal to the NCC corresponding to the second security parameter. This embodiment is particularly applicable to scenarios where the first access network device has not locally received any new (unused) {NH, NCC} corresponding to the terminal configured by the core network device. In such scenarios, the handover processing performed by the terminal is the same as that described in the foregoing embodiments, and will not be repeated here.

The processing of exchanging measurement reports before the terminal receives the cell handover command and the processing of the first access network device for determining the target cell are the same as those described in the foregoing embodiments, and will not be repeated here.

In some possible implementations, the processing performed by the terminal may further include one of: receiving first algorithm-related information from the first access network device, where the first algorithm-related information is used for determining a target security algorithm corresponding to the second access network device, the first algorithm-related information includes security algorithm(s) supported by the at least one candidate access network device, and the target security algorithm includes at least one of: a target integrity protection algorithm, or a target encryption algorithm; receiving second algorithm-related information from the second access network device, where the second algorithm-related information is used for determining a target security algorithm corresponding to the second access network device, and the second algorithm-related information includes a target security algorithm corresponding to the second access network device and/or security algorithm(s) supported by the second access network device.

The target integrity protection algorithm is used by the terminal to perform integrity protection-related processing on information based on an integrity protection key, and the target encryption algorithm is used by the terminal to perform confidentiality-related processing on information based on an encryption key. The integrity protection key is related to the first security key, and the encryption key is also related to the first security key. This embodiment does not limit the method for generating the integrity protection key and the encryption key.

Optionally, the processing of the first access network device may further include: transmitting the first algorithm-related information to the terminal, where the first algorithm-related information is used for determining the target security algorithm corresponding to the second access network device, the first algorithm-related information includes security algorithm(s) supported by the at least one candidate access network device, and the target security algorithm includes at least one of: a target integrity protection algorithm, or a target encryption algorithm.

The first algorithm-related information may be transmitted to the terminal together with the first configuration information. For example, the first algorithm information and the first configuration information may be carried in the same message. Alternatively, the first algorithm-related information and the first configuration information may be transmitted to the terminal separately, that is, they may be carried in different messages, which is not limited or exhaustively listed here.

The first access network device may obtain the security algorithm supported by each candidate access network device from the core network device. For example, the second configuration information may include the security algorithm supported by each candidate access network device.

After handing over to the second access network device, the terminal may determine the security algorithm(s) supported by the second access network device based on the first algorithm-related information, and then determine the target security algorithm corresponding to the second access network device. For example, the second access network device may support only one security algorithm, and the terminal can directly use the security algorithm as the target security algorithm corresponding to the second access network device. In another example, the second access network device may support multiple security algorithms, and the terminal may randomly select one from the multiple security algorithms supported by the second access network device as the target security algorithm corresponding to the second access network device; alternatively, the terminal may, based on one or more security algorithms it supports, select a matching one from the multiple security algorithms supported by the second access network device as the target security algorithm corresponding to the second access network device.

Optionally, the processing of the second access network device may further include: transmitting second algorithm-related information to the terminal, where the second algorithm-related information is used for determining the target security algorithm corresponding to the second access network device. The second algorithm-related information includes the target security algorithm corresponding to the second access network device and/or the security algorithm(s) supported by the second access network device, and the target security algorithm includes at least one of: a target integrity protection algorithm, or a target encryption algorithm. The second algorithm-related information may be obtained during any interaction after the terminal establishes the connection with the second access network device.

The way in which the terminal determines the target security algorithm corresponding to the second access network device based on the second algorithm-related information may include one of the following: if the second algorithm-related information includes the target security algorithm corresponding to the second access network device, the terminal may directly determine the target security algorithm corresponding to the second access network device; if the second algorithm-related information includes one or more security algorithms supported by the second access network device, the terminal may select the target security algorithm from the one or more security algorithms supported by the second access network device. Here, the way in which the terminal selects the target security algorithm from the one or more security algorithms supported by the second access network device is the same as that described in the foregoing embodiments, and will not be repeated here.

In related technologies, R18 introduces the intra-CU LTM function, which allows the base station to trigger UE handover procedure via lower-layer L1/L2 signaling. However, in the L3-based handover procedure, RRC signaling is used between the gNB and the UE to transmit a handover command. Using the lower-layer L1/L2 signaling to trigger the handover procedure can reduce the delay during the mobility of UE. The existing LTM procedure only involves the intra-CU scenarios, where LTM candidate cells belong to the same base station or the same CU, and therefore does not involve any key update process. However, in inter-CU LTM, since the target cell to be handed over may belong to another base station, the need for key update arises. Yet, in inter-CU LTM, if the lower-layer L1/L2 signaling is used to transmit the NCC, due to the lack of security protection in the lower-layer signaling, it can easily be obtained by an eavesdroppers or tampered with, leading to a mismatch between security contexts generated by the UE and the gNB, thereby causing handover failure.

In view of this, the embodiments of the present application provide a security mechanism for the inter-CU LTM procedure. Specifically, during the interaction between the source base station and the AMF, the AMF provides security parameters to the source base station and a target base station according to LTM candidate cell configuration information provided by the source base station. The switch manner indication and some security parameters are included in the LTM candidate cell configuration by the source base station and are provided to the UE during the LTM advance preparation procedure. During LTM execution, the UE determines the target cell to be handed over in the next step according to the received handover command, handovers to the target base station to which the target cell belongs by using horizontal switch or vertical switch according to the switch manner included in the configuration information corresponding to the target base station to which the target cell belongs, and calculates the security key according to the NCC included in the configuration information.

By adopting the above scheme, the terminal can obtain in advance the first security parameter corresponding to each candidate access network device that is configured by the network side. The first security parameter includes the first NCC and/or an indication of key derivation manner. In this way, during the handover procedure involving the access network device (e.g., inter-CU LTM), the terminal can use the pre-configured security parameters to update the security key, thereby avoiding security issues caused by the need to obtain the security parameters corresponding to the target access network device through lower-layer signaling interaction during the handover in the related technologies.

FIG. 13 is a schematic flowchart of a communication method performed by a terminal according to an embodiment of the present application. The method includes at least some of the following content.
In S1310, in a case where a first security key between the terminal and a second access network device is horizontally derived, second information is received from the second access network device, where the second information carries a second NCC, and the second NCC is used for vertically deriving a third security key between the terminal and the second access network device.

FIG. 14 is a schematic flowchart of a communication method performed by a second access network device according to another embodiment of the present application. The method includes at least some of the following content.
In S1410, in a case where a horizontally derived first security key between a terminal and the second access network device is obtained, a path switch request is transmitted to a core network device.
In S1420, a path switch response message is received from the core network device, where the path switch response message carries a second NCC and a second NH, and the second NH is used for vertically deriving a third security key between the second access network device and the terminal;
In S1430, second information is transmitted to the terminal, where the second information carries the second NCC, and the second NCC is used by the terminal to vertically derive the third security key.

FIG. 5 is a schematic flowchart of a communication method performed by a core network device according to another embodiment of the present application. The method includes at least some of the following content.
In S1510, a path switch request is received from a second access network device.
In S1520, a path switch response message is transmitted to the second access network device, where the path switch response message carries a second NCC and a second NH.

In some implementations, the processing of the terminal further includes: receiving a cell handover command, where the cell handover command is used to indicate a target cell, and the target cell is one of one or more cells corresponding to the second access network device; and horizontally deriving a first security key based on a second security key between the first access network device and the terminal.

The processing of the first access network device further includes: horizontally deriving a first security key between the terminal and the second access network device based on a second security key; and transmitting first information to the second access network device.

The processing of the second access network device further includes: receiving the first information from the first access network device, where the first information includes: the first security key, and an NCC corresponding to the first security key. The NCC corresponding to the first security key is less than the second NCC. The NCC corresponding to the first security key is equal to the NCC corresponding to the second security key. The process of horizontally deriving the first security key by the first access network device is the same as that described in the foregoing embodiments and will not be repeated here.

The cell handover command mentioned above may come from the first access network device or the second access network device, which will not be repeated in this embodiment.

In some implementations, the path switch request may be used to request the core network device to allocate a new security parameter used for vertically deriving a third security key between the second access network device and the terminal. The core network device may select any value greater than the NCC corresponding to the first security key as the value of the second NCC, and calculate the second NH based on the second NCC.

On the terminal side, vertically deriving the third security key between the terminal and the second access network device based on the second NCC may be: obtaining the second NH by performing vertical derivation based on the second NCC, and deriving the third security key between the terminal and the second access network device based on the second NH.

In the above process, during or before the terminal executes the handover procedure, it is unnecessary for the terminal to interact with the core network device via the access network side device. Instead, the terminal performs horizontal derivation to obtain the first security key by default.

For example, when the UE receives an inter-CU LTM handover command (the command may not include an NCC) forwarded by the SgNB or a TgNB through the SgNB, the UE uses the current second security key between itself and the SgNB to horizontally derive a first security key between itself and the TgNB. The TgNB receives the first security key K_{NG-RAN*} calculated horizontally and the corresponding NCC from the SgNB. Once the TgNB receives new {second NH, second NCC} from the AMF through path switch, the TgNB initiates intra-CU handover and uses vertical key update to update the key between itself and the UE to obtain the third security key. This approach is intended to avoid the case where all security keys are horizontally derived in scenarios where the UE performs inter-LTM handover.

By adopting the above scheme, in the case where the terminal has obtained the first security key derived horizontally during handover, the terminal can obtain a new NCC to vertically derive the third security key between itself and the second access network device. In this way, during the handover procedure involving access network devices (e.g., inter-CU LTM), it is unnecessary for the terminal to interact with the core network side, which can avoid the delay caused by the interaction with the core network device, thereby ensuring handover efficiency. Furthermore, performing the vertical key derivation once after the handover can also prevent the issue where all security keys used in terminal handover scenarios are horizontally derived.

FIG. 16 is a schematic block diagram of a terminal according to an embodiment of the present application, which including:
a first communication unit 1601, configured to receive first configuration information from a first access network device, where the first configuration information includes first security parameter(s) corresponding to at least one candidate access network device, and the first security parameter(s) include at least one of: an indication of a key derivation manner, or a first NCC.

As shown in FIG. 16, the terminal further includes a first processing unit 1602, which is configured to: determine, based on a second access network device to which a target cell belongs and the first configuration information, a first security parameter corresponding to the second access network device, where the second access network device is one of the at least one candidate access network device; and calculate a first security key between the terminal and the second access network device based on the first security parameter corresponding to the second access network device.

The first communication unit is configured to receive a cell handover command, where the cell handover command is used to indicate the target cell.

The first communication unit is configured to perform one of the following:
receive first algorithm-related information from the first access network device; where the first algorithm-related information is used for determining a target security algorithm corresponding to the second access network device, the first algorithm-related information includes security algorithm(s) supported by the at least one candidate access network device, and the target security algorithm includes at least one of: a target integrity protection algorithm, or a target encryption algorithm;
receive second algorithm-related information from the second access network device; where the second algorithm-related information is used for determining a target security algorithm corresponding to the second access network device, and the second algorithm-related information includes the target security algorithm corresponding to the second access network device and/or security algorithm(s) supported by the second access network device.

The first processing unit is configured to perform one of the following: delete the first security parameter(s) corresponding to the at least one candidate access network device; delete a first security parameter corresponding to a candidate access network device whose first NCC is less than an NCC corresponding to the first security key.

The first processing unit is configured to, in a case where a historical security parameter corresponding to a first candidate access network device of the at least one candidate access network device is stored, delete the historical security parameter corresponding to the first candidate access network device.

FIG. 17 is a schematic block diagram of a first access network device according to an embodiment of the present application, which includes:
a second communication unit 1701, configured to transmit first configuration information to a terminal, where the first configuration information includes first security parameter(s) corresponding to at least one candidate access network device, and the first security parameter(s) include at least one of: an indication of a key derivation manner, or a first next hop chaining counter (NCC).

The second communication unit is configured to receive second configuration information from a core network device, where the second configuration information is used for determining the first security parameter(s) corresponding to the at least one candidate access network device.

The second communication unit is configured to transmit a request message to the core network device, where the request message is used to request allocation of the second configuration information.

The second configuration information includes at least one of: second security parameter(s) corresponding to the at least one candidate access network device; a second security parameter corresponding to each second candidate access network device, where the each second candidate access network device is a candidate access network device of the at least one candidate access network device that is not configured with a second security parameter; or one or more NCCs and an NH corresponding to each NCC, where the each NCC and its corresponding NH are used for determining the second security parameter(s) corresponding to the at least one candidate access network device.

The second security parameter includes at least one of: an indication of a key derivation manner, a first NCC, or a first NH.

As shown in FIG. 17, the first access network device further includes a second processing unit 1702, which configured to calculate, based on a second security parameter corresponding to a second access network device to which a target cell corresponding to the terminal belongs, a first security key between the terminal and the second access network device that is one of the at least one candidate access network device; and
the second communication unit is configured to transmit first information to the second access network device, where the first information includes: the first security key, and the NCC corresponding to the first security key.

The first information further includes one of the following: an unused second security parameter corresponding to a candidate access network device; a second security parameter corresponding to a candidate access network device whose first NCC is greater than the NCC corresponding to the first security key.

The second configuration information includes the first security parameter(s) corresponding to the at least one candidate access network device, and the second communication unit is configured to transmit first information to a second access network device to which a target cell corresponding to the terminal belongs, where the first information is used to indicate the second access network device to calculate a first security key between the second access network device and the terminal, and the second access network device is one of the at least one candidate access network device.

The first information includes at least one of: a second security key between the first access network device and the terminal, or an NCC corresponding to the second security key.

The indication of the key derivation manner is an indication of horizontal key derivation, and the first NCC is an NCC corresponding to a second security key between the first access network device and the terminal; and the second processing unit is configured to horizontally derive a first security key between the terminal and the second access network device based on the second security key, where the second access network device corresponds to a target cell of the terminal; and
the second communication unit is configured to transmit first information to the second access network device, where the first information includes: the first security key, and an NCC corresponding to the first security key, and the NCC corresponding to the first security key is equal to the NCC corresponding to the second security key.

The second communication unit is configured to transmit first algorithm-related information to the terminal, where the first algorithm-related information is used for determining a target security algorithm corresponding to the second access network device, the first algorithm-related information includes security algorithm(s) supported by the at least one candidate access network device, and the target security algorithm includes at least one of: a target integrity protection algorithm, or a target encryption algorithm.

FIG. 18 is a schematic block diagram of a core network device according to an embodiment of the present application, which includes:
a third communication unit 1801, configured to transmit second configuration information to a first access network device, where the second configuration information is used by the first access network device to determine first security parameter(s) corresponding to at least one candidate access network device, and the first security parameter(s) includes at least one of: an indication of a key derivation manner, or a first next hop chaining counter (NCC).

The third communication unit is configured to receive a request message from the first access network device, where the request message is configured to request allocation of the second configuration information.

The second configuration information includes at least one of: second security parameter(s) corresponding to the at least one candidate access network device; a second security parameter corresponding to each second candidate access network device, where each second candidate access network device is a candidate access network device of the at least one candidate access network device that is not configured with a second security parameter; or one or more NCCs and an NH corresponding to each NCC, where the each NCC and its corresponding NH are used for determining the second security parameter(s) corresponding to the at least one candidate access network device.

The second configuration information includes the first security parameter(s) corresponding to each candidate access network device, and the third communication unit is configured to transmit third configuration information to the at least one candidate access network device, where the third configuration information corresponding to each candidate access network device includes a second security parameter corresponding to the candidate access network device.

The second security parameter includes at least one of: an indication of a key derivation manner, a first NCC, or a first NH.

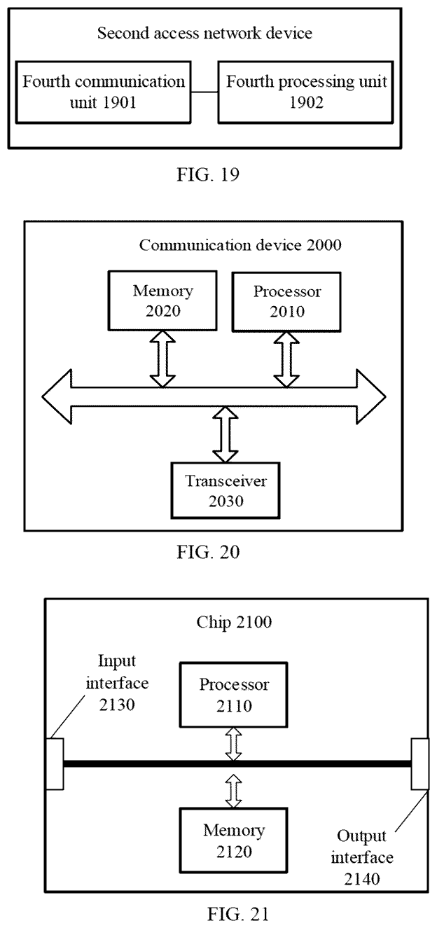

FIG. 19 is a schematic block diagram of a second access network device according to an embodiment of the present application, which includes:
a fourth communication unit 1901, configured to receive third configuration information from a core network device, where the third configuration information includes a second security parameter corresponding to the second access network device, and the second security parameter includes at least one of: an indication of a key derivation manner, a first next hop chaining counter (NCC), or a first next hop key (NH).

As shown in FIG. 19, the second access network device further includes a fourth processing unit 1902, which is configured to calculate a first security key based on the second security parameter. The fourth communication unit is configured to receive first information from a first access network device, where the first information is used to indicate the second access network device to calculate a first security key between the second access network device and the terminal.

The fourth communication unit is configured to transmit second algorithm-related information to a terminal, where the second algorithm-related information is used for determining a target security algorithm corresponding to the second access network device, and the second algorithm-related information includes the target security algorithm corresponding to the second access network device and/or security algorithm(s) supported by the second access network device, the target security algorithm includes at least one of: a target integrity protection algorithm, or a target encryption algorithm.

A terminal provided in another embodiment of the present application includes:
a first communication unit, configured to, in a case where a first security key between the terminal and a second access network device is horizontally derived, receive second information from the second access network device, where the second information carries a second NCC, and the second NCC is used for vertically deriving a third security key between the terminal and the second access network device.

A second access network device provided in another embodiment of the present application includes:
a fourth communication unit, configured to:
in a case where a horizontally derived first security key between a terminal and the second access network device is obtained, transmit a path switch request to a core network device;
receive a path switch response message from the core network device, where the path switch response message carries a second NCC and a second NH, the second NH is used for vertically deriving a third security key between the second access network device and the terminal; and
transmit second information to the terminal, where the second information carries the second NCC, and the second NCC is used by the terminal to vertically derive the third security key.

A core network device provided in another embodiment of the present application includes:
a third communication unit, configured to:
receive a path switch request from a second access network device; and
transmit a path switch response message to the second access network device, where the path switch response message carries a second NCC and a second NH.

The device in the embodiments of the present application can implement the corresponding functions of the various devices in the foregoing communication method embodiments. For the procedure, function, implementation and beneficial effect corresponding to each module (e.g., sub-module, unit or component) in the device, reference may be made to the corresponding descriptions in the above method embodiments and will not be repeated here. It should be noted that the functions described with respect to the various modules (e.g., sub-modules, units or components) in the device in the embodiments of the present application may be implemented by different modules (e.g., sub-modules, units or components) or implemented by the same module (e.g., sub-module, unit or component).

FIG. 20 is a schematic block diagram of a communication device 2000 according to an embodiment of the present application. The communication device 2000 includes a processor 2010, and the processor 2010 can invoke a computer program from a memory and run the computer program, to cause the communication device 2000 to implement the methods in the embodiments of the present application.

In one possible implementation, the communication device 2000 may further include a memory 2020. The processor 2010 can invoke a computer program from the memory 2020 and run the computer program to cause the communication device 2000 to implement the method in the embodiments of the present application. The memory 2020 may be a separate device independent of the processor 2010, or may be integrated into the processor 2010. In one possible implementation, the communication device 2000 may further include a transceiver 2030, and the processor 2010 can control the transceiver 2030 to communicate with other devices, specifically, to transmit information or data to other devices, or receive information or data transmitted from other devices. The transceiver 2030 may include a transmitter and a receiver. The transceiver 2030 may further include antenna(s), and the number of antenna(s) may be one or more.

The present application provides a terminal, which includes: a processor, and a memory communicating with the processor. The memory is configured to store instructions which, when executed by the processor, cause the terminal to perform: receiving first configuration information from a first access network device. The first configuration information includes first security parameter(s) corresponding to at least one candidate access network device, and the first security parameter(s) include at least one of: an indication of a key derivation manner, or a first NCC.

The embodiments of the present application provide a first access network device, which includes: a processor, and a memory communicating with the processor. The memory is configured to store instructions which, when executed by the processor, cause the first access network device to perform: transmitting first configuration information to a terminal. The first configuration information includes first security parameter(s) corresponding to at least one candidate access network device. The first security parameter(s) include at least one of: an indication of a key derivation manner, or a first NCC.

The embodiments of the present application provide a core network device, which includes: a processor, and a memory communicating with the processor. The memory is configured to store instructions which, when executed by the processor, cause the core network device to perform: transmitting second configuration information to a first access network device. The second configuration information is used by the first access network device to determine first security parameter(s) corresponding to at least one candidate access network device. The first security parameter(s) include at least one of: an indication of a key derivation manner, for a first NCC.

The embodiments of the present application provide a second access network device, which includes: a processor, and a memory communicating with the processor. The memory is configured to store instructions which, when executed by the processor, cause the second access network device to perform: receiving third configuration information from a core network device. The third configuration information includes a second security parameter corresponding to the second access network device, and the second security parameter includes at least one of: an indication of a key derivation manner, a first NCC, or a first NH.

The embodiments of the present application provide a terminal, which includes: a processor, and a memory communicating with the processor. The memory is configured to store instructions which, when executed by the processor, cause the terminal to perform: receiving second information from the second access network device in a case where a first security key between the terminal and a second access network device is horizontally derived. The second information carries a second NCC, and the second NCC is used for vertically deriving a third security key between the terminal and the second access network device.

The embodiments of the present application provide a second access network device, which includes: a processor, and a memory communicating with the processor. The memory is configured to store instructions which, when executed by the processor, cause the second access network device to perform: transmitting a path switch request to a core network device in a case where a horizontally derived first security key between a terminal and the second access network device is obtained; receiving a path switch response message from the core network device, where the path switch response message carries a second NCC and a second NH, and the second NH is used for vertically deriving a third security key between the second access network device and the terminal; and transmitting second information to the terminal, where the second information carries the second NCC, and the second NCC is used by the terminal to vertically derive the third security key.

The embodiments of the present application provide a core network device, which includes: a processor, and a memory communicating with the processor. The memory is configured to store instructions which, when executed by the processor, cause the core network device to perform: receiving a path switch request from a second access network device; and transmitting a path switch response message to the second access network device, where the path switch response message carries a second NCC and a second NH.

FIG. 21 is a schematic block diagram of a chip 2100 according to the embodiments of the present application. The chip 2100 includes a processor 2110, and the processor 2110 can invoke a computer program from a memory and run the computer program, to implement the methods in the embodiments of the present application. In one possible implementation, the chip 2100 may further include a memory 2120. The processor 2110 can invoke a computer program from the memory 2120 and run the computer program, to implement the methods performed by various devices in the embodiments of the present application. The memory 2120 may be a separate device independent of the processor 2110, or may be integrated into the processor 2110. In one possible implementation, the chip 2100 may further include an input interface 2130. The processor 2110 can control the input interface 2130 to communicate with other devices or chips, and specifically, to acquire information or data transmitted by other devices or chips. In one possible implementation, the chip 2100 may further include an output interface 2140. The processor 2110 can control the output interface 2140 to communicate with other devices or chips, and specifically, to output information or data to other devices or chips. In one possible implementation, the chip may be applied to various devices in the embodiments of the present application, and the chip can implement the corresponding procedures implemented by various devices in the various methods of the embodiments of the present application, which will not be repeated here for brevity. It should be understood that the chip mentioned in the embodiments of the present application may also be referred to as a system on chip, a system chip, a chip system or a system-on-chip chip, etc.

The above-mentioned processor may be a general-purpose processor, a digital signal processor, a field programmable gate array, an application specific integrated circuit or other programmable logic devices, transistor logic devices, and discrete hardware components, etc. The above-mentioned general-purpose processor may be a microprocessor or may be any conventional processor, etc. The above-mentioned memory may be a volatile memory or a non-volatile memory, or may include both the volatile memory and non-volatile memory.

It should be understood that the above-mentioned memory is exemplary but not a limited illustration. For example, the memory in the embodiments of the present application may also be a static random access memory, a dynamic random access memory, etc.

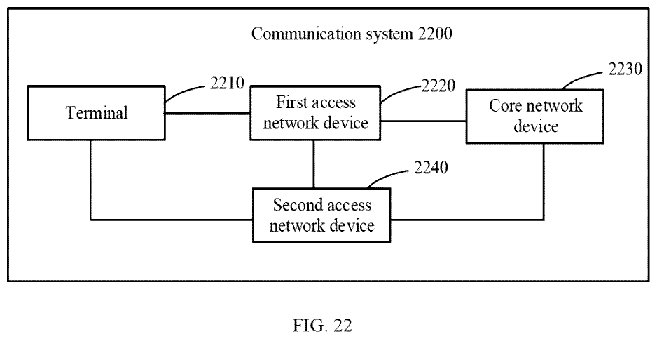

FIG. 22 is a schematic block diagram of a communication system 2200 according to the embodiments of the present application. The communication system 2200 includes a terminal 2210, a first access network device 2220, a core network device 2230, and a second access network device 2240. The above embodiments may be implemented in whole or in part by software, hardware, firmware, or any combination thereof. When the above embodiments are implemented by using software, they may be implemented in the form of a computer program product in whole or in part. The computer program product includes one or more computer instructions. When the computer program instructions are loaded and executed on a computer, processes or functions according to the embodiments of the present application are generated in whole or in part. The computer may be a general-purpose computer, a dedicated computer, a computer network, or any other programmable apparatus. The computer instructions may be stored in a non-transitory computer-readable storage medium or transmitted from one non-transitory computer-readable storage medium to another non-transitory computer-readable storage medium, for example, the computer instructions may be transmitted from a website site, computer, server, or data center to another website site, computer, server, or data center via wired (such as coaxial cable, fiber optic, digital subscriber line) or wireless (such as infrared, radio, microwave, etc.) means. The non-transitory computer-readable storage medium may be any available medium accessible to the computer, or a data storage device, such as a server or a data center that integrates one or more available media. The available medium may be a magnetic medium (e.g., a hard disk) or a semiconductor medium (e.g., a solid state disk), etc.

It should be understood that, in the various embodiments of the present application, the numerical order of the foregoing processes does not imply an order of execution. The execution order of the each process should be determined by its function and internal logic, but should not constitute any limitation on the implementation processes of the embodiments of the present application.

Those skilled in the art can clearly understand that, for the convenience and brevity of the description, reference may be made to the corresponding processes in the above method embodiments regarding the specific working processes of the systems, apparatuses and units described above, which will not be repeated here.

The foregoing descriptions are merely specific implementations of the present application. However, the protection scope of the present application is not limited thereto, and any skilled familiar with this technical field, within the technical scope disclosed in the present application, can readily envisage variations or substitutions, all of which should fall within the protection scope of the present application. Therefore, the protection scope of the present application should be subject to the protection scope defined by the claims.

What is claimed is:

1. A terminal, comprising: a processor, and a memory communicating with the processor; wherein the memory is configured to store instructions which, when executed by the processor, cause the terminal to perform:
receiving first configuration information from a first access network device, wherein the first configuration information comprises first security parameter(s) corresponding to at least one candidate access network device, and the first security parameter(s) comprise at least one of: an indication of a key derivation manner, or a first next hop chaining counter (NCC).

2. The terminal according to claim 1, wherein when the instructions are executed by the processor, the terminal is caused to further perform:
receiving a cell handover command, wherein the cell handover command is used to indicate a target cell;
based on a second access network device to which the target cell belongs and the first configuration information, determining a first security parameter corresponding to a second access network device; wherein the second access network device is one of the at least one candidate access network device; and
calculating a first security key between the terminal and the second access network device based on the first security parameter corresponding to the second access network device.

3. The terminal according to claim 2, wherein when the instructions are executed by the processor, the terminal is caused to further perform:
receiving first algorithm-related information from the first access network device, wherein the first algorithm-related information is used for determining a target security algorithm corresponding to the second access network device, the first algorithm-related information comprises security algorithm(s) supported by the at least one candidate access network device, and the target security algorithm comprises at least one of: a target integrity protection algorithm, or a target encryption algorithm; or
receiving second algorithm-related information from the second access network device, wherein the second algorithm-related information is used for determining a target security algorithm corresponding to the second access network device, and the second algorithm-related information comprises the target security algorithm corresponding to the second access network device and/or security algorithm(s) supported by the second access network device.

4. The terminal according to claim 2, wherein when the instructions are executed by the processor, the terminal is caused to further perform:
deleting the first security parameter(s) corresponding to the at least one candidate access network device; or
deleting a first security parameter corresponding to a candidate access network device whose first NCC is less than an NCC corresponding to the first security key.

5. The terminal according to claim 1, wherein when the instructions are executed by the processor, the terminal is caused to further perform:
in a case where a historical security parameter corresponding to a first candidate access network device of the at least one candidate access network device is stored, deleting the historical security parameter corresponding to the first candidate access network device.

6. A first access network device, comprising: a processor, and a memory communicating with the processor; wherein the memory is configured to store instructions which, when executed by the processor, cause the first access network device to perform:
transmitting first configuration information to a terminal, wherein the first configuration information comprises first security parameter(s) corresponding to at least one candidate access network device, and the first security parameter(s) comprise at least one of: an indication of a key derivation manner, or a first next hop chaining counter (NCC).

7. The first access network device according to claim 6, wherein when the instructions are executed by the processor, the first access network device is caused to further perform:
receiving second configuration information from a core network device, wherein the second configuration information is used for determining the first security parameter(s) corresponding to the at least one candidate access network device.

8. The first access network device according to claim 7, wherein when the instructions are executed by the processor, the first access network device is caused to further perform:
transmitting a request message to the core network device, wherein the request message is used to request allocation of the second configuration information.

9. The first access network device according to claim 7, wherein the second configuration information comprises at least one of:
second security parameter(s) corresponding to the at least one candidate access network device;
a second security parameter corresponding to each second candidate access network device, wherein the each second candidate access network device is a candidate access network device of the at least one candidate access network device that is not configured with a second security parameter; or
one or more NCCs and an NH corresponding to each NCC, wherein the each NCC and its corresponding NH are used for determining the second security parameter(s) corresponding to the at least one candidate access network device.

10. The first access network device according to claim 9, wherein a second security parameter comprises at least one of: an indication of a key derivation manner, a first NCC, or a first next hop key (NH).

11. The first access network device according to claim 10, wherein when the instructions are executed by the processor, the first access network device is caused to further perform:
based on a second security parameter corresponding to a second access network device to which a target cell corresponding to the terminal belongs, calculating a first security key between the terminal and the second access network device; wherein the second access network device is one of the at least one candidate access network device; and
transmitting first information to the second access network device, wherein the first information comprises: the first security key, and an NCC corresponding to the first security key.

12. The first access network device according to claim 11, wherein the first information further comprises:
an unused second security parameter corresponding to a candidate access network device; or
a second security parameter corresponding to a candidate access network device whose first NCC is greater than the NCC corresponding to the first security key.

13. The first access network device according to claim 7, wherein the second configuration information comprises the first security parameter(s) corresponding to the at least one candidate access network device; and when the instructions are executed by the processor, the first access network device is caused to further perform:
transmitting first information to a second access network device to which a target cell corresponding to the terminal belongs, wherein the first information is used to indicate the second access network device to calculate a first security key between the second access network device and the terminal, and the second access network device is one of the at least one candidate access network device.

14. The first access network device according to claim 13, wherein the first information comprises at least one of: a second security key between the first access network device and the terminal, or an NCC corresponding to the second security key.

15. The first access network device according to claim 6, wherein the indication of the key derivation manner is an indication of horizontal key derivation, and the first NCC is an NCC corresponding to a second security key between the first access network device and the terminal; and when the instructions are executed by the processor, the first access network device is caused to further perform:
horizontally deriving a first security key between the terminal and the second access network device based on the second security key, wherein the second access network device corresponds to a target cell of the terminal; and
transmitting first information to the second access network device, wherein the first information comprises: the first security key, and an NCC corresponding to the first security key; wherein the NCC corresponding to the first security key is equal to an NCC corresponding to the second security key.

16. The first access network device according to claim 6, wherein when the instructions are executed by the processor, the first access network device is caused to further perform:
transmitting first algorithm-related information to the terminal, wherein the first algorithm-related information is used for determining a target security algorithm corresponding to the second access network device, the first algorithm-related information comprises security algorithm(s) supported by the at least one candidate access network device, and the target security algorithm comprises at least one of: a target integrity protection algorithm, or a target encryption algorithm.

17. A second access network device, comprising: a processor, and a memory communicating with the processor; wherein the memory is configured to store instructions which, when executed by the processor, cause the second access network device to perform
receiving third configuration information from a core network device, wherein the third configuration information comprises a second security parameter corresponding to the second access network device, and the second security parameter comprises at least one of: an indication of a key derivation manner, a first next hop chaining counter (NCC), or a first next hop key (NH).

18. The second access network device according to claim 17, wherein when the instructions are executed by the processor, the second access network device is caused to further perform:
receiving first information from a first access network device, wherein the first information is used to indicate the second access network device to calculate a first security key between the second access network device and the terminal; and
calculating the first security key based on the second security parameter.

19. The second access network device according to claim 17, wherein when the instructions are executed by the processor, the second access network device is caused to further perform:
transmitting second algorithm-related information to a terminal, wherein the second algorithm-related information is used for determining a target security algorithm corresponding to the second access network device, the second algorithm-related information comprises the target security algorithm corresponding to the second access network device and/or security algorithm(s) supported by the second access network device, the target security algorithm comprises at least one of: a target integrity protection algorithm, or a target encryption algorithm.
